(19) United States
(12) Patent Application Publication
(10) Pub. No.: US 2025/0261282 A1
(43) Pub. Date: Aug. 14, 2025

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US); Mitsutaka HATA, Yokohama-shi (JP)

(73) Assignee: KYOCERA Corporation, Kyoto (JP)

(21) Appl. No.: 19/197,936

(22) Filed: May 2, 2025

Related U.S. Application Data
(63) Continuation of application No. PCT/JP2023/039401, filed on Nov. 1, 2023.
(60) Provisional application No. 63/421,765, filed on Nov. 2, 2022.

(51) Int. Cl. H04W 76/40; H04W 36/08; H04W 76/20

(52) U.S. Cl. CPC H04W 76/40; H04W 36/08; H04W 76/20

(57) ABSTRACT

A communication method executed by a user equipment in a mobile communication system for providing a Multicast/Broadcast Service (MBS) includes the steps of: performing multicast reception in a Radio Resource Control (RRC) inactive state based on a multicast configuration received from a network through dedicated signaling; determining to access the network for update of the multicast configuration in response to determination that the update is necessary; and determining whether to apply or skip access control for restricting the access, based on configuration information from the network.

### RELATED APPLICATIONS

The present application is a continuation based on PCT Application No. PCT/JP2023/039401, filed on Nov. 1, 2023, which claims the benefit of U.S. Provisional Patent Application No. 63/421,765 filed on Nov. 2, 2022. The content of which is incorporated by reference herein in their entirety.

### TECHNICAL FIELD

The present disclosure relates to a communication method used in a mobile communication system.

### BACKGROUND

The 3rd Generation Partnership Project (3GPP) has defined the technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of Multicast/Broadcast Services (MBS) of 5G/NR (see, for example, Non-Patent Document 1).

### CITATION LIST

### Non-Patent Literature

Non-Patent Document 1: 3GPP Technical Specification: TS 38.300 V17.2.0

### SUMMARY

According to a first aspect, a communication method executed by a user equipment in a mobile communication system for providing a Multicast/Broadcast Service (MBS) includes the steps of: performing multicast reception in a Radio Resource Control (RRC) inactive state based on a multicast configuration received from a network through dedicated signaling; determining to access the network for update of the multicast configuration in response to determination that the update is necessary; and determining whether to apply or skip access control for restricting the access, based on configuration information from the network.

According to a second aspect, a communication method executed by a user equipment in a mobile communication system for providing a Multicast/Broadcast Service (MBS) includes the steps of: performing multicast reception in a Radio Resource Control (RRC) inactive state based on a multicast configuration received from a network; and in the RRC inactive state, considering a frequency to which a cell having transmitted the multicast configuration belongs to be a highest priority in cell reselection.

According to a third aspect, a communication method executed by a user equipment in a mobile communication system for providing a Multicast/Broadcast Service (MBS) includes the steps of: receiving, from a network, dedicated signaling including designation information for designating a frequency; performing multicast reception in a Radio Resource Control (RRC) inactive state; and in the RRC inactive state, determining a frequency priority of cell reselection based on the designation information without applying processing of considering a frequency determined by the user equipment to be a highest priority in the cell reselection.

### BRIEF DESCRIPTION OF THE DRAWINGS

FIG. 1 is a diagram illustrating a configuration of a mobile communication system according to an embodiment.

FIG. 2 is a diagram illustrating a configuration of a User Equipment (UE) according to the embodiment.

FIG. 3 is a diagram illustrating a configuration of a gNB (base station) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of an operation of enabling a UE 100 in an RRC inactive state to perform multicast reception.

FIG. 7 is a diagram for describing a general cell reselection procedure.

FIG. 8 is a diagram illustrating a schematic flow of the general cell reselection procedure.

FIG. 9 is a diagram illustrating an operation example of the mobile communication system according to a first operation pattern.

FIG. 10 is a diagram illustrating a first operation example of the mobile communication system according to a second operation pattern.

FIG. 11 is a diagram illustrating a second operation example of the mobile communication system according to the second operation pattern.

FIG. 12 is a diagram illustrating an example of a gap pattern of an MBS.

### DESCRIPTION OF EMBODIMENTS

A mobile communication system according to embodiments will be described with reference to the drawings. In the description of the drawings, the same or similar parts are denoted by the same or similar reference signs.

### (1) System Configuration

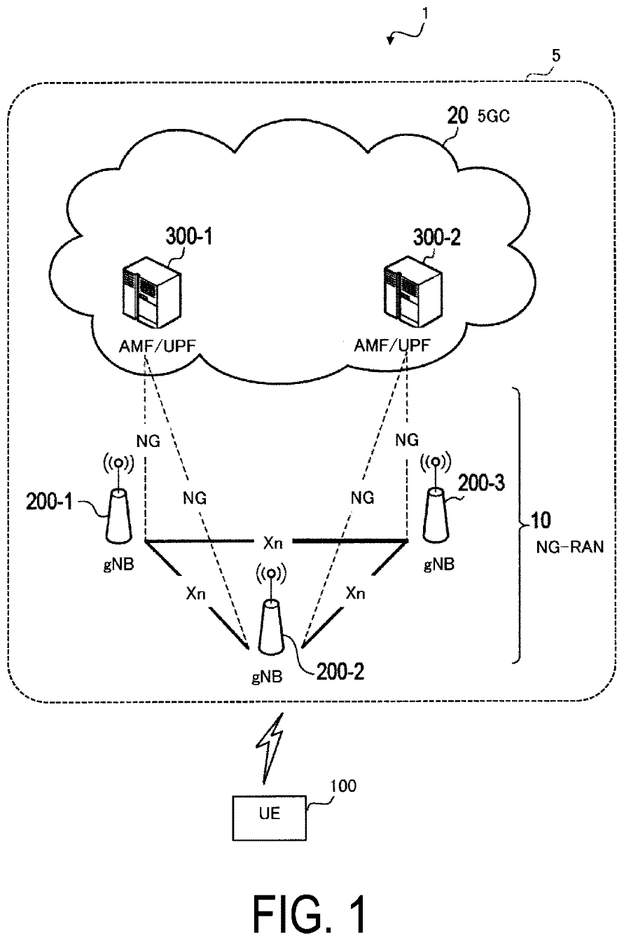

First, a configuration of a mobile communication system 1 according to the embodiments will be described. FIG. 1 is a diagram illustrating a configuration of the mobile communication system 1 according to the embodiment. The mobile communication system 1 complies with the 5th Generation System (5GS) of the 3GPP standards. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. Hereinafter, the NG-RAN 10 may be simply referred to as the RAN 10. The 5GC 20 may be simply referred to as the Core Network (CN) 20. The RAN 10 and the CN 20 constitute a network of the mobile communication system 1.

The UE 100 is a movable wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface that is an inter-base station interface. Each gNB 200 manages one or more cells. The gNB 200 performs wireless communication with the UE 100 that has established connection with the cell of the gNB 200. The gNB 200 has a Radio Resource Management (RRM) function, a routing function of user data (hereinafter simply referred to as “data”), a measurement control function for mobility control/scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be also connected to an Evolved Packet Core (EPC) corresponding to a core network of LTE. An LTE base station can be also connected to the 5GC. The LTE base station and the gNB can be also connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface that is an interface between a base station and the core network.

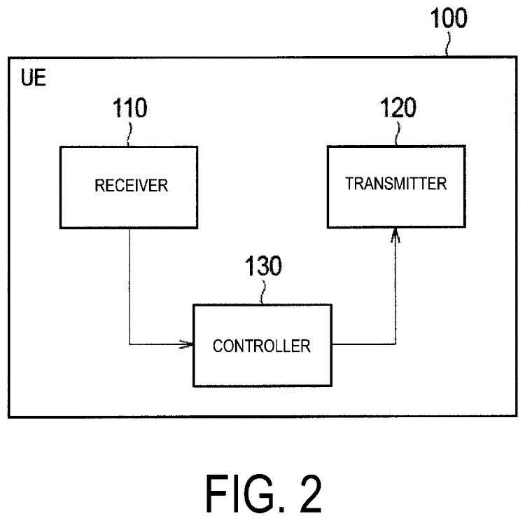

FIG. 2 is a diagram illustrating a configuration of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (reception signal) and outputs the baseband signal to the controller 130.

The transmitter 120 performs various types of transmission under control of the controller 130. The transmitter 120 includes an antenna and a transmission device. The transmission device converts a baseband signal (transmission signal) output by the controller 130 into a radio signal and transmits the radio signal through the antenna.

The controller 130 performs various types of control and processing in the UE 100. Such processing includes processing of respective layers to be described below. The operations of the UE 100 described above and below may be also performed under control of a controller 230. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

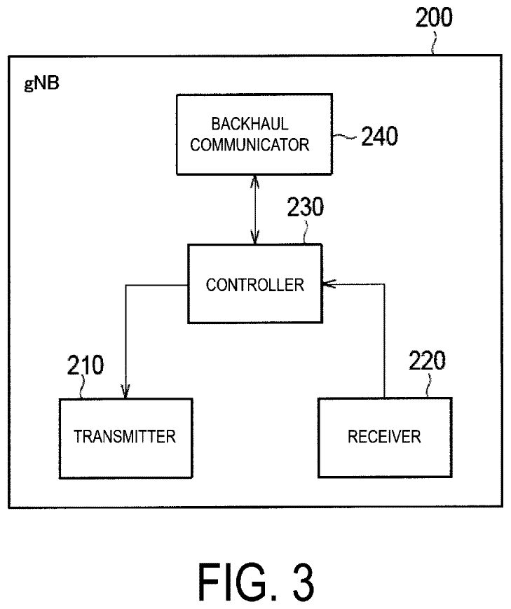

FIG. 3 is a diagram illustrating a configuration of the gNB 200 (base station) according to the embodiment. The gNB 200 includes a transmitter 210, a receiver 220, the controller 230, and a backhaul communicator 240. The transmitter 210 and the receiver 220 constitute a wireless communicator that performs wireless communication with the UE 100. The backhaul communicator 240 constitutes a network communicator that communicates with the CN 20.

The transmitter 210 performs various types of transmission under control of the controller 230. The transmitter 210 includes an antenna and a transmission device. The transmission device converts a baseband signal (transmission signal) output by the controller 230 into a radio signal and transmits the radio signal through the antenna.

The receiver 220 performs various types of reception under control of the controller 230. The receiver 220 includes an antenna and a reception device. The reception device converts a radio signal received through the antenna into a baseband signal (reception signal) and outputs the baseband signal to the controller 230.

The controller 230 performs various types of control and processing in the gNB 200. Such processing includes processing of respective layers to be described later. The operations of the gNB 200 described above and below may be also performed under the control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface that is an inter-base station interface. The backhaul communicator 240 is connected to the AMF/UPF 300 via an NG interface that is an interface between a base station and the core network. Note that the gNB 200 may include a Central Unit (CU) and a Distributed Unit (DU) (i.e., functions are divided), and both units may be connected via an F1 interface that is a fronthaul interface.

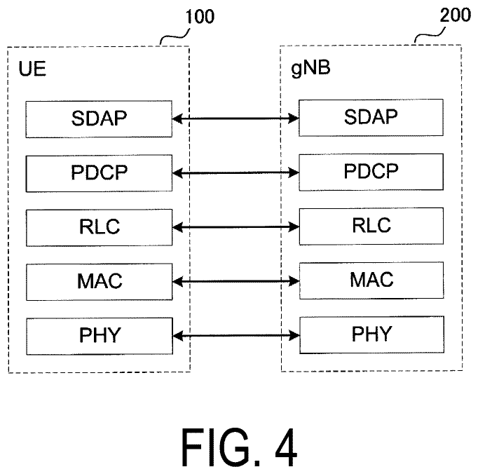

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives Downlink Control Information (DCI) transmitted from the gNB 200 over a Physical Downlink Control CHannel (PDCCH). More specifically, the UE 100 blind-decodes the PDCCH using a Radio Network Temporary Identifier (RNTI) and acquires successfully decoded DCI as DCI addressed to the UE 100. A Cyclic Redundancy Code (CRC) parity bit scrambled by the RNTI is added to the DCI transmitted from the gNB 200.

The MAC layer performs priority control of data, retransmission processing through Hybrid Automatic Repeat reQuest (HARQ: Hybrid ARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes and a Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

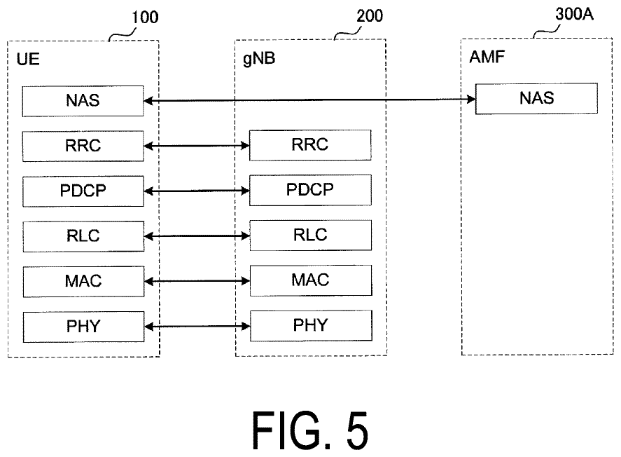

FIG. 5 is a diagram illustrating a configuration of a protocol stack of a radio interface of a control plane handling signaling (control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between RRC of the UE 100 and RRC of the gNB 200, the UE 100 is in an RRC connected state. When connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also referred to simply as an “NAS”) that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. Each layer lower than the NAS layer will be referred to as an AS layer (also referred to simply as an “AS”).

### (2) MBS

The mobile communication system 1 can perform distribution with high resource efficiency by using the Multicast/Broadcast Service (MBS).

In a case of a multicast communication service (also referred to as “MBS multicast”), the same service and the same specific content data are simultaneously provided to a specific UE set. That is, not every UE 100 in the multicast service area is permitted to receive data. The multicast communication services are distributed to the UE 100 using a multicast session that is a type of an MBS session. The UE 100 can receive the multicast communication services in the RRC connected state using mechanisms such as Point-to-Point (PTP) and/or Point-to-Multipoint (PTM) distribution. The UE 100 may receive the multicast communication services in the RRC inactive (or RRC idle) state. Such a distribution mode will be also referred to as “distribution mode 1”.

In a case of the broadcast communication services (also referred to as “MBS broadcast”), the same service and the same specific content data are provided simultaneously to every UE 100 in a geographic area. That is, every UE 100 in the broadcast service area is permitted to receive the data. The broadcast communication services are distributed to the UE 100 using a broadcast session that is a type of an MBS session. The UE 100 can receive the broadcast communication services in any state of the RRC idle state, the RRC inactive state, and the RRC connected state. Such a distribution mode will be also referred to as “distribution mode 2”.

Main logical channels used for MBS distribution are a Multicast Traffic CHannel (MTCH), a Dedicated Traffic CHannel (DTCH), and a Multicast Control CHannel (MCCH). The MTCH is a PTM downlink channel for transmitting MBS data of a multicast session and/or a broadcast session from the network 10 to the UE 100. The DTCH is a PTP channel for transmitting MBS data of a multicast session from the network 10 to the UE 100. The MCCH is a PTM downlink channel for transmitting MBS broadcast control information associated with one or more MTCHs from the network 10 to the UE 100.

Regarding a configuration of MBS broadcast, the UE 100 in the RRC idle state, the RRC inactive state, or the RRC connected state receives a PTM configuration for a broadcast session (e.g., parameters necessary for MTCH reception) via the MCCH. Parameters necessary for reception of the MCCH (MCCH configuration) are provided through system information. More specifically, system information block/type 20 (SIB 20) includes the MCCH configuration. Note an SIB type 21 (SIB 21) includes information relating to service continuity of MBS broadcast reception. The MCCH provides a list of all broadcast services including ongoing sessions transmitted on the MTCH, and the related information of the broadcast session includes an MBS session identifier (e.g., Temporary Mobile Group Identity (TMGI)), related MTCH scheduling information, and information relating to neighboring cells providing a specific service on the MTCH.

On the other hand, as for MBS multicast, the current technical specifications of the 3GPP enable the UE 100 to receive data of multicast sessions only in the RRC connected state. When the UE 100 having joined a multicast session is in the RRC connected state and the multicast session is activated, the gNB 200 transmits an RRC reconfiguration message including a PTM configuration relating to the multicast session to the UE 100. Such a PTM configuration is also referred to as a Multicast Radio Bearer (MRB) configuration, an MTCH configuration, or a multicast configuration. Such an MRB configuration (MRB-ToAddMod) includes an MBS session identifier (mbs-SessionId), an MRB identifier (mrb-Identity), and other parameters such as a PDCP configuration (pdcp-Config) for an MRB (multicast MRB) to be configured for the UE 100.

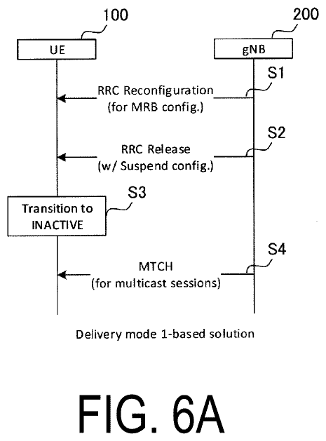

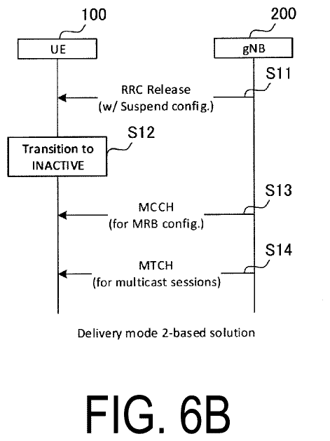

In the following embodiment, an operation of enabling the UE 100 in the RRC inactive state to perform multicast reception will be mainly described. FIG. 6 is a diagram illustrating an overview of the operation.

As a solution for the UE 100 in the RRC inactive state to perform multicast reception, a solution based on the distribution mode 1 illustrated in FIG. 6A and a solution based on the distribution mode 2 illustrated in FIG. 6B are considered.

In the solution based on the distribution mode 1 illustrated in FIG. 6A, in step S1, the gNB 200 transmits an RRC Reconfiguration message including the MBS configuration (multicast configuration) relating to multicast sessions to the ULE 100 in the RRC connected state. The UE 100 receives the multicast data on the MTCH via the multicast sessions (multicast MRB) based on the multicast configuration received in the RRC Reconfiguration message.

In step S2, the gNB 200 transmits to the UE 100 in the RRC connected state an RRC release (Release) message for causing the UE 100 to transition to the RRC inactive state. The RRC Release message includes a configuration (Suspend Config.) for the RRC inactive state.

In step S3, the UE 100 transitions from the RRC connected state to the RRC inactive (INACTIVE) state in response to reception of the RRC Release message in step S2.

In step S4, the UE 100 in the RRC inactive state continues using the multicast configuration in step S1 to receive the multicast data on the MTCH through the multicast sessions.

This enables the UE 100 in the RRC inactive state to perform multicast reception. Note that, although an example where multicast configuration is performed using an RRC Reconfiguration message has been described, multicast configuration may be performed using an RRC Release message.

Both the RRC Reconfiguration message and the RRC Release message are RRC messages transmitted per UE on the Dedicated Control CHannel (DCCH), and are hereinafter also referred to as dedicated RRC messages.

On the other hand, in the solution based on the distribution mode 2 illustrated in FIG. 6B, in step S11, the gNB 200 transmits to the UE 100 in the RRC connected state an RRC Release message for causing the UE 100 to transition to the RRC inactive state. The RRC Release message includes a configuration (Suspend Config.) for the RRC inactive state.

In step S12, the UE 100 transitions to the RRC inactive (INACTIVE) state in response to reception of the RRC Release message in step S11.

In step S13, the gNB 200 transmits the MCCH including the MBS configuration (multicast configuration) relating to the multicast sessions. The UE 100 receives the MCCH. Note that the UE 100 receives the SIB 20 prior to the reception of the MCCH, and receives the MCCH based on the SIB 20. Note that the MCCH transmission (and reception) may be performed before step S11 or may be performed simultaneously with step S11.

In step S14, the UE 100 in the RRC inactive state receives the multicast data on the MTCH via the multicast sessions based on the multicast configuration received on the MCCH in step S13. This enables the UE 100 in the RRC inactive state to perform multicast reception.

### (3) Cell Reselection

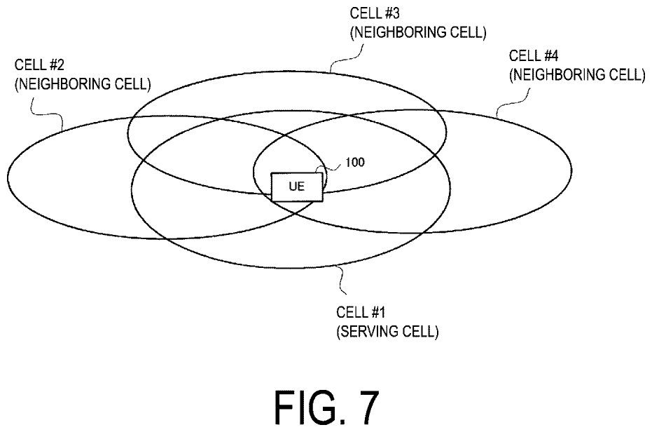

FIG. 7 is a diagram for describing a general cell reselection procedure. The UE 100 in the RRC idle state or the RRC inactive state performs the cell reselection procedure to migrate from a current serving cell (cell #1) to a neighboring cell (any one of cells #2 to #4) as the UE 100 migrates. More specifically, the UE 100 specifies a neighboring cell on which the UE needs to camp by the cell reselection procedure, and reselects the specified neighboring cell. Frequencies (carrier frequencies) that are the same between the current serving cell and the neighboring cell will be referred to as intra-frequencies, and frequencies (carrier frequencies) that are different between the current serving cell and the neighboring cell will be referred to as inter-frequencies. The current serving cell and the neighboring cell may be managed by the same gNB 200. The current serving cell and the neighboring cell may be managed by the gNBs 200 different from each other.

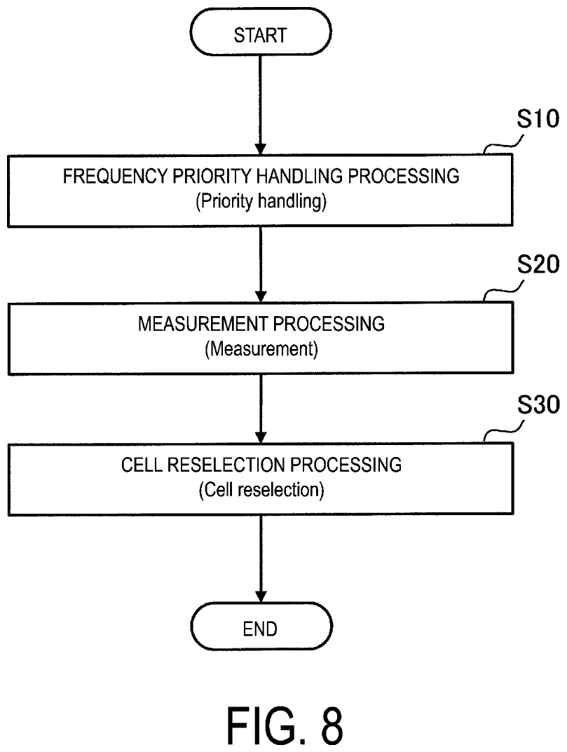

FIG. 8 is a diagram illustrating a schematic flow of the general cell reselection procedure.

In step S10, the UE 100 performs frequency priority handling processing based on a priority of each frequency (also referred to as an “absolute priority”, a “cell reselection priority”, or a “dedicated priority”) designated by the gNB 200 by, for example, a System Information Block (SIB) or an RRC release message. More specifically, the UE 100 manages the frequency priority designated by the gNB 200 per frequency.

In step S20, the UE 100 performs measurement processing of measuring radio qualities of the serving cell and each of the neighboring cells. The UE 100 measures reception powers and reception qualities of reference signals transmitted by the serving cell and each of the neighboring cells, more specifically, a Cell Defining-Synchronization Signal and PBCH block (CD-SSB). For example, the UE 100 measures the radio quality of the frequency having higher priorities than a priority of the frequency of the current serving cell at all times, and, as for frequency having priorities equal to or lower than the priority of the frequency of the current serving cell, measures the radio quality of the frequency having priorities equal to or lower than the priority of the frequency of the current serving cell when the radio quality of the current serving cell goes below a predetermined quality.

In step S30, the UE 100 performs the cell reselection processing of reselecting a cell that the UE 100 camps on based on the measurement result in step S20. For example, when the priority of a frequency of a neighboring cell is higher than the priority of the current serving cell and the neighboring cell satisfies a predetermined quality criterion (i.e., minimal necessary quality criterion) for a predetermined period of time, the UE 100 may perform cell reselection for the neighboring cell. When the priorities of the frequencies of the neighboring cells are the same as the priority of the current serving cell, the UE 100 may rank the radio qualities of the neighboring cells, and perform cell reselection for the neighboring cells ranked higher than the ranking of the current serving cell for a predetermined period of time. When the priorities of the frequencies of the neighboring cells are lower than the priority of the current serving cell, the radio quality of the current serving cell is lower than a certain threshold, and the radio qualities of the neighboring cells are continuously higher than another threshold for the predetermined period of time, the UE 100 may perform cell reselection for the neighboring cell.

The UE 100 that supports the MBS and is in an RRC idle state or an RRC inactive state adds and applies following changes to above-described cell reselection. More specifically, when the UE 100 that is receiving or is interested in receiving MBS broadcast services via Point-to-Multipoint (PTM) can receive these MBS broadcast services only by camping on a frequency for providing these MBS broadcast services, the UE 100 is permitted to make these frequencies the highest priority (higher than the priorities configured by other networks).

On the other hand, when the MBS broadcast service that the UE 100 is interested in cannot be used (after an end of a session), or when the UE 100 is no longer interested in receiving the broadcast service, the UE 100 no longer prioritizes the frequency. The UE 100 that is receiving or is interested in receiving the MBS broadcast services via PTM is permitted to make frequency at which these MBS broadcast services cannot be received the lowest priority (lower than the priorities configured by the other networks).

### (4) Access Control

The mobile communication system 1 according to the embodiments supports access control that is referred to as Unified Access Control (UAC). Such access control makes it possible to avoid, for example, a situation where a network 5 is congested can be avoided. Details of the UAC are defined in chapter 5.3.14 of 3GPP Technical Specifications: TS38. 331, and an overview of the UAC will be described here.

According to the UAC, access restriction can be performed for the UE 100 in all RRC states (the RRC idle state, the RRC inactive state, and the RRC connected state). Each communication request of the UE 100 is associated with one access category and one or more access identities. The restriction can be performed for the gNB 200 for each combination. The access category is an identifier of service type. The access identity is an identifier of call type. The gNB 200 notifies the UE 100 of a target access identity to be restricted and a parameter value for each access category. Every time a communication request occurs, the UE 100 determines whether restriction is necessary based on the access category and the access identity, and performs a restriction operation according to the parameter value when restriction is necessary.

### (5) Operation According to Embodiment

Each operation pattern according to the embodiment will be described.

A scenario where the UE 100 in the RRC inactive state performs multicast reception using a distribution mode 1-based solution is mainly assumed hereinafter. In this regard, according to a second operation pattern and a third operation pattern to be described below, a distribution mode 2-based solution may be applied.

Although a scenario where the UE 100 in the RRC inactive state performs multicast reception is assumed, a scenario where the UE 100 in the RRC idle state performs multicast reception may be assumed. That is, the RRC idle state in the following description of the embodiment may be read as an RRC inactive state.

### (5.1) First Operation Pattern

It is assumed that, after the network 5 performs PTM configuration (multicast configuration) for the UE 100 by dedicated signaling, the UE 100 is performing (or waiting for) multicast reception in the RRC inactive state. The UE 100 in the RRC inactive state accesses the network 5 and receives a new PTM configuration from the network 5 in response to the necessity of the PTM configuration update.

More specifically, the UE 100 in the RRC inactive state accesses the network 5 by transmitting an RRC Resume Request message to the network 5. Note that, when the UE 100 having transmitted the RRC Resume Request message to the network 5 receives the RRC Release message including a new PTM configuration from the network 5 in response to the RRC Resume Request message, the UE 100 can acquire the new PTM configuration without transitioning to the RRC connected state.

Here, access control based on UAC is normally applied to the UE 100 in the RRC inactive state before the UE 100 transmits the RRC Resume Request message to the network 5. When access is restricted by access control, the UE 100 cannot transmit the RRC Resume Request message to the network 5.

It is considered to, when the UE 100 that performs multicast reception in the RRC inactive state accesses the network 5 for PTM configuration update, allow the UAC to be skipped. Since, when unicast communication is not performed only with update of the PTM configuration, the load on the network 5 does not increase, it is reasonable that restriction due to access control is not applied. However, one of motivations for multicast reception in the RRC inactive state is to mitigate network congestion, and it is not preferable that a large number of the UEs 100 skip the UAC during network congestion and access the network 5. Hence, in this operation pattern, whether to apply or skip the UAC when the UE 100 that performs multicast reception in the RRC inactive state accesses the network 5 for PTM configuration update can be configured by the network 5.

That is, in this operation pattern, first, the UE 100 performs multicast reception in the RRC inactive state based on the multicast configuration (PTM configuration) received from the network 5 by dedicated signaling. Second, in response to determination that the multicast configuration update is necessary, the UE 100 determines to access the network 5 for the update. Third, the UE 100 determines whether to apply or skip access control (UAC) for restricting the access, based on configuration information (also referred to as “UAC skip permission/non-permission information”) from the network 5.

Thus, whether to apply or skip UAC when the UE 100 that performs multicast reception in the RRC inactive state accesses the network 5 for the PTM configuration update can be configured by the network 5. For example, the network 5 (gNB 200) can configure the UE 100 to apply UAC during network congestion, and configure the UE 100 to skip the UAC if the network is not congested.

In this operation pattern, the UE 100 receives the configuration information from the network 5 (gNB 200). The configuration information is information for configuring whether to permit the UE 100 to skip the access control (UAC) when accessing the network 5 only for the purpose of updating the multicast configuration (PTM configuration). Thus, whether the UAC may be skipped only in the case of the PTM configuration update can be provided as notification from the gNB 200 to the UE 100 and configured by the gNB 200 for the UE 100.

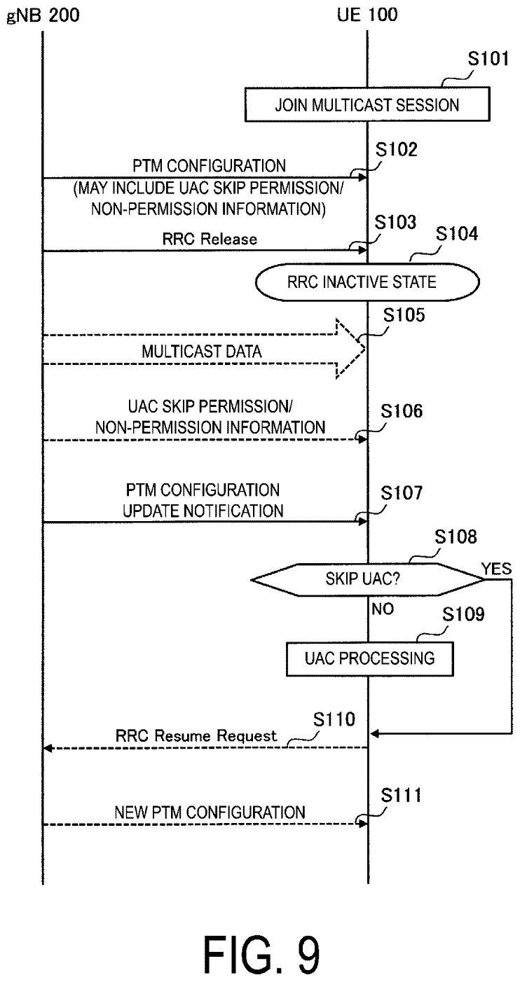

FIG. 9 is a diagram illustrating an operation example of the mobile communication system 1 according to this operation pattern.

In step S101, the UE 100 in the RRC connected state joins a specific multicast session (here, multicast session #1).

In step S102, the gNB 200 transmits dedicated signaling including a PTM configuration that is necessary for reception of the multicast session #1 to the UE 100 in the RRC connected state. The dedicated signaling may be an RRC Reconfiguration message. The dedicated signaling may include UAC skip permission/non-permission information to be described below. The UE 100 stores the received PTM configuration.

In step S103, the gNB 200 transmits to the UE 100 in the RRC connected state an RRC release message (more specifically, the RRC Release message including Suspend Config.) for causing the UE 100 to transition to the RRC inactive state. Step S103 may be performed at the same time as step S102. The RRC Release message may include the above-described PTM configuration and/or UAC skip permission/non-permission information.

In step S104, the UE 100 transitions to the RRC inactive state in response to reception of the RRC Release message in step S103.

In step S105, the UE 100 receives (or waits for) multicast data of the multicast session #1 in the RRC inactive state.

In step S106, the gNB 200 may transmit to the UE 100 the UAC skip permission/non-permission information indicating whether or not skipping the UAC only in the case of the PTM configuration update is permitted. The UE 100 receives the UAC skip permission/non-permission information. The UAC skip permission/non-permission information is transmitted using any of a System Information Block (SIB), a paging message, and an MCCH.

Note that the UAC skip permission/non-permission information may be, for example, information on “UAC skip permitted”, “UAC skip not permitted”, or “whether UAC may be skipped”. The UAC skip permission/non-permission information may be provided as notification per multicast session (for example, per TMGI). For example, a set of the UAC skip permission/non-permission information and a corresponding TMGI (or MRB ID) may be transmitted and received.

For example, at a time of network congestion, the gNB 200 may notify the UE 100 of UAC skip not permitted using the UAC skip permission/non-permission information. On the other hand, when the network congestion is resolved, the gNB 200 may notify the UE 100 of the UAC skip permitted using the UAC skip permission/non-permission information.

In step S107, the gNB 200 transmits a PTM configuration update notification to the UE 100. The UE 100 receives the notification. The notification may be a paging message including a TMGI of a multicast session whose PTM configuration is to be updated. Here, it is assumed that the gNB 200 notifies the UE 100 of the PTM configuration update for the multicast session #1. In response to the reception of the notification, the UE 100 determines to perform access (RRC resume processing) to the gNB 200 for the PTM configuration update.

In step S108, when the UE 100 performs RRC resume only for the purpose of the PTM configuration update, the UE 100 determines whether to apply or skip the UAC based on the UAC skip permission/non-permission information. Here, when the UE 100 determines to skip the UAC, the UE 100 considers the access through the PTM configuration update to be prioritized over the UAC. Note that, when another trigger for RRC resume (e.g., uplink data having been generated) is also detected, the UE 100 may determine to apply UAC regardless of the UAC skip permission/non-permission information. If the UAC is determined to be skipped (step S108: YES), the UAC processing is skipped to proceed to step S110.

On the other hand, if the UAC is determined to be applied (step S108: NO), in step S109, the UE 100 applies the above-described UAC, and determines whether the access to the gNB 200 is permitted or barred (restricted). If it is determined that the access to the gNB 200 is barred, the UE 100 refrains from accessing the gNB 200. Here, the description will continue assuming that the access to the gNB 200 has been permitted.

In step S110, the UE 100 accesses the gNB 200 and transmits the RRC Resume Request message to the gNB 200. The RRC Resume Request message may include information indicating the PTM configuration update.

In step S111, the gNB 200 transmits to the UE 100 the updated new PTM configuration for the multicast session #1. The UE 100 receives and stores the new PTM configuration.

Note that, when multicast reception while in the RRC inactive state is determined to be performed after the PTM configuration is updated, the UE 100 may determine whether to apply or skip the UAC based on the UAC skip permission/non-permission information (step S108). That is, when the UE 100 expects to receive the RRC Release message including the new PTM configuration after transmitting RRC Resume Request, that is, when the UE 100 expects that the UE 100 can acquire the new PTM configuration without transitioning to the RRC connected state, the UE 100 may perform the determination in step S108. For example, in the case of a multicast session on which the UE 100 performs only reception (e.g., a multicast session such as television broadcasting), the UE 100 may expect to receive RRC Release. On the other hand, in the case of a multicast session involving UL transmission like a group call, reception of the multicast session in the RRC connected state can be expected.

### (5.2) Second Operation Pattern

As described above, as for MBS broadcast, a mechanism that allows the MBS frequency to be considered to be the highest priority in the RRC idle state/RRC inactive state is adopted. On the other hand, as for MBS multicast, there exists no such mechanism in the current technical specifications.

However, when the MBS multicast can be received in the RRC inactive state, the UE 100 having camped on a cell in which the UE 100 cannot receive the MBS multicast cannot perform multicast reception. The MBS multicast differs from the MBS broadcast in that full control of the gNB 200 is assumed, and the UE 100 does not change interest in an MBS in the RRC inactive state (more specifically, when the interest changes, the UE 100 needs to transition to the RRC connected state and leave the session or join the session by NAS). Therefore, the gNB 200 may be able to control the frequency using a UE context held in the gNB 200 at a time of the RRC connected state. Accordingly, in the case of the MBS multicast, there exists a possibility where frequency priority handling processing different from that of MBS broadcast is necessary.

In this operation pattern, the UE 100 considers the frequency of the serving cell at a time when the PTM configuration is received (or RRC Release is received) to be the highest priority of cell reselection. That is, the UE 100 performs multicast reception in the RRC inactive state based on the multicast configuration (PTM configuration) received from the network 5. In the RRC inactive state, the UE 100 considers the frequency to which the cell having transmitted the PTM configuration belongs to be the highest priority in cell reselection.

More specifically, in this operation pattern, it is assumed that the frequency to which the cell having transmitted the PTM configuration to the UE 100 belongs is a frequency that supports multicast. The UE 100 autonomously determines the frequency considered to be the highest priority in cell reselection, so that the gNB 200 does not need to explicitly designate the frequency to the UE 100, and signaling load can be kept from increasing. Consequently, when the frequency is not designated by the gNB 200, the UE 100 can autonomously wait for the frequency at which the multicast can be received as the highest priority.

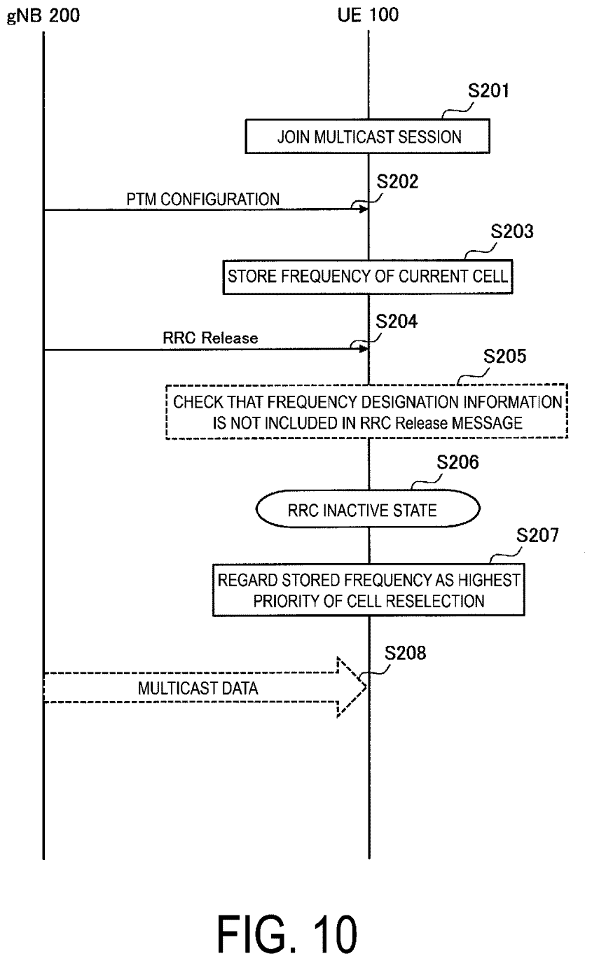

FIG. 10 is a diagram illustrating a first operation example of the mobile communication system 1 according to this operation pattern.

In step S201, the UE 100 in the RRC connected state joins a multicast session (here, the multicast session #1).

In step S202, the gNB 200 transmits, to the UE 100 in the RRC connected state, dedicated signaling including the PTM configuration necessary for reception of the multicast session #1. The dedicated signaling may be an RRC Reconfiguration message. The UE 100 stores the received PTM configuration.

In step S203, the UE 100 stores the frequency to which the cell having transmitted the PTM configuration in step S202 belongs.

In step S204, the gNB 200 transmits, to the UE 100 in the RRC connected state, an RRC release message (more specifically, the RRC Release message including Suspend Config.) for causing the UE 100 to transition to the RRC inactive state. Step S204 may be performed at the same time as step S202. The RRC Release message may include the above-described PTM configuration.

In step S205, the UE 100 may check that RRC Release does not include frequency priority information (dedicated priority and the like). The UE 100 may recognize that the UE 100 receives (or waits for) the multicast session #1 in the RRC inactive state.

In step S206, the UE 100 transitions to the RRC inactive state in response to reception of the RRC Release message in step S204.

In step S207, the UE 100 considers the frequency stored in step S203 to be the highest priority, the frequency being a frequency to which the serving cell having received the PTM configuration (or RRC Release) belongs. Thus, the UE 100 can easily maintain a state where the UE 100 camps on a cell that supports the multicast session #1.

In step S208, the UE 100 receives (or waits for) multicast data of the multicast session #1 in the RRC inactive state.

In the above-described first operation example, it is assumed that the gNB 200 does not explicitly designate to the UE 100 the frequency prioritized in cell reselection. However, if the gNB 200 designates the frequency to the UE 100, it is desirable that the UE 100 does not autonomously determine the frequency considered to be the highest priority. Hence, in this operation pattern, when the frequency is designated by dedicated signaling (dedicated priority and/or de-prioritization request and the like), the UE 100 does not apply processing of considering the frequency specified by the UE itself to be the highest priority.

More specifically, the UE 100 receives from the network 5 dedicated signaling including designation information for designating a frequency (also referred to as “frequency designation information”), and performs multicast reception in the RRC inactive state. In the RRC inactive state, the UE 100 determines the frequency priority in cell reselection based on the designation information without applying the processing of considering the frequency determined by the UE 100 to be the highest priority in cell reselection. Here, the operation of determining the frequency priority in cell reselection based on the designation information is the same as or similar to the known frequency priority handling processing.

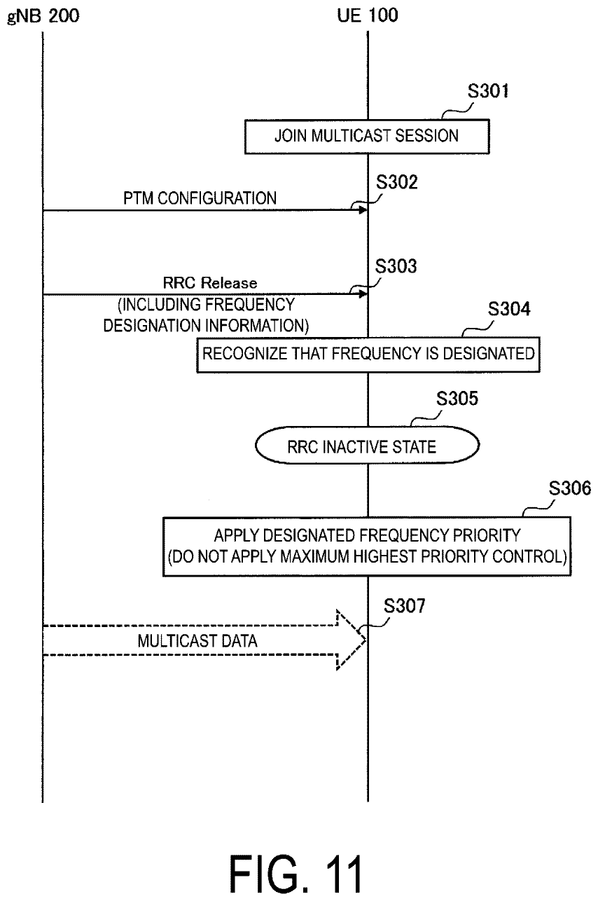

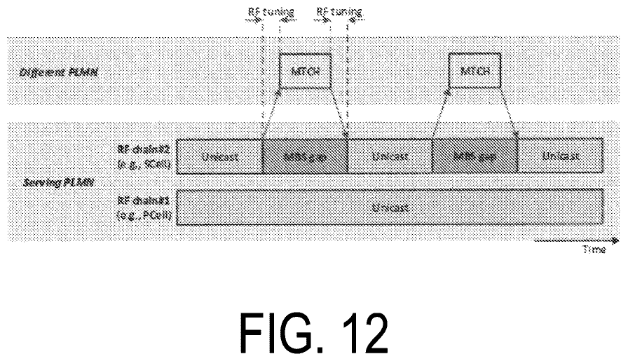

FIG. 11 is a diagram illustrating a second operation example of the mobile communication system 1 according to this operation pattern. Redundant description of an operation that overlaps the above-described operation will be omitted.

In step S301, the UE 100 joins the multicast session.

In step S302, the gNB 200 transmits the PTM configuration to the UE 100 in the RRC connected state. The UE 100 receives the PTM configuration in the RRC connected state.

In step S303, the gNB 200 transmits, to the UE 100 in the RRC connected state, an RRC release message for causing the UE 100 to transition to the RRC inactive state. The UE 100 receives the RRC Release message, and transitions to the RRC inactive state. Step S303 may be performed at the same time as step S302. The RRC Release message may include the above-described PTM configuration.

The RRC Release message in step S303 (or the PTM configuration in step S302) includes frequency designation information for designating the frequency. The frequency designation information is at least one of the following information.
Dedicated priority: an information element for designating a cell reselection priority;
De-prioritization request: an information element for designating a frequency or a Radio Access Technology (RAT) as the lowest priority; and
Redirected Carrier Info: an information element for designating a frequency or a RAT to camp on.

The frequency designation information may be a new information element for designating a multicast frequency. The new information element is, for example, a “multicast reception frequency” or the like. The new information element may be for each TMGI (associated with each TMGI).

The RRC Release message in step S303 (or the PTM configuration in step S302) may further include an information element indicating whether the frequency designation information is mandatory or optional. In a case of “mandatory”, the flow proceeds to the following processing. On the other hand, in a case of “optional”, processing of considering the frequency to be the highest priority may be performed as performed in the existing specification.

In step S304, the UE 100 recognizes that the frequency (frequency priority) is explicitly designated by the gNB 200.

In step S305, the UE 100 transitions to the RRC inactive state in response to reception of the RRC Release message in step S303.

In step S306, the UE 100 does not perform processing of considering a certain frequency (so-called MBS frequency) designated by the UE 100 to be the highest priority, and applies the frequency priority designated by the gNB 200. The UE 100 may consider the frequency designated by the gNB 200 (“multicast reception frequency”) to be the highest priority. The UE 100 may consider the frequency designated by the gNB 200 (de-prioritization request) to be the lowest priority. Thus, the UE 100 can easily maintain a state where the UE 100 camps on a cell that supports the multicast session #1.

In step S307, the UE 100 receives (or waits for) multicast data of the multicast session #1 in the RRC inactive state.

Note that, when already performing multicast reception in the RRC inactive state, the UE 100 may consider the frequency of the cell that is currently transmitting the multicast session #1 to be the highest priority instead of step S306.

The above “information indicating mandatory/optional” need not be limited to multicast reception in the RRC inactive state. For example, the state may be the RRC idle state or the information may be applied when there exists no interest in multicast reception.

### (6) Other Embodiments

The UE 100 can execute unicast reception and MBS broadcast reception using the same hardware in the RRC connected state. In this case, the gNB 200 needs to schedule unicast in consideration of processing capability of the UE 100. The UE 100 can report to the gNB 200 information relating to the processing capability relating to MBS broadcast reception. The information relating to the processing capability includes at least information of a frequency, a subcarrier spacing, and a bandwidth of the MBS broadcast. The information relating to the processing capability may be reported using an MBS interest information message. The MBS interest information message can include information of a TMGI of interest, a frequency, and a priority of unicast MBS broadcast. On the other hand, when the information relating to the processing capability is known by the gNB 200, notification from the UE 100 is unnecessary. Hence, the gNB 200 may notify the UE 100 of information as to whether the information relating to the processing capability is necessary. The information as to whether the information relating to the processing capability is necessary may be provided as notification of necessity depending on whether the MBS broadcast is a session provided by the same Public Land Mobile Network (PLMN) or a session provided by another PLMN. By comparing a PLMN ID included in the TMGI of interest and a current serving PLMN, the UE 100 can identify whether the session is provided by the same PLMN. The information as to whether the information relating to the processing capability is necessary may be provided as notification of necessity through the TMGI. The gNB 200 may notify the UE 100 that the report is unnecessary for the TMGI already having the information already provided as notification from another UE 100 and relating to the processing capability.

In the embodiments, the processing example of the highest priority has been described. However, the present disclosure may be applied to processing of a lowest priority. The above-described operation flows can be not only separately and independently implemented, but also implemented in combination of two or more of the operation flows. For example, some steps of one operation flow may be added to another operation flow or some steps of one operation flow may be replaced with some steps of another operation flow. In each flow, all steps need not be necessarily executed, and only some of the steps may be executed.

Although the example where the base station is an NR base station (gNB) has been described in the above-described embodiments and examples, the base station may be an LTE base station (eNB) or a 6G base station. The base station may be a relay node such as an Integrated Access and Backhaul (IAB) node. The base station may be a DU of the IAB node. The UE 100 may be a mobile termination (MT) of the IAB node.

The term “network node” mainly means a base station, but may also mean a core network apparatus or part (a CU, a DU, or an RU) of the base station.

A program causing a computer to execute each processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least part of the UE 100 or the gNB 200 may be configured as a semiconductor integrated circuit (a chipset or a System on a Chip (SoC)).

The phrases “based on” and “depending on/in response to” used in the present disclosure do not mean “based only on” and “depending only on/in response only to” unless specifically stated otherwise. The phrase “based on” means both “based only on” and “based at least partially on”. Similarly, the phrase “depending on/in response to” means both “depending only on/in response only to” and “depending at least partially on/in response at least partially to”. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (7) Supplementary Note 1

Features relating to the above-described embodiments will be described below as supplementary notes.

### Supplementary Note 1

A communication method executed by a user equipment in a mobile communication system for providing a Multicast/Broadcast Service (MBS) includes the steps of:
performing multicast reception in a Radio Resource Control (RRC) inactive state based on a multicast configuration received from a network through dedicated signaling;
determining to access the network for update of the multicast configuration in response to determination that the update is necessary; and
determining whether to apply or skip access control for restricting the access, based on configuration information from the network.

### Supplementary Note 2

The communication method described in Supplementary Note 1 further includes receiving the configuration information from the network, and
the configuration information is information for configuring whether to permit the user equipment to skip the access control when the access is performed only for a purpose of the update.

### Supplementary Note 3

A communication method executed by a user equipment in a mobile communication system for providing a Multicast/Broadcast Service (MBS) includes the steps of:
performing multicast reception in a Radio Resource Control (RRC) inactive state based on a multicast configuration received from a network; and
in the RRC inactive state, considering a frequency to which a cell having transmitted the multicast configuration belongs to be a highest priority in cell reselection.

### Supplementary Note 4

A communication method executed by a user equipment in a mobile communication system for providing a Multicast/Broadcast Service (MBS) includes the steps of:
receiving, from a network, dedicated signaling including designation information for designating a frequency;
performing multicast reception in a Radio Resource Control (RRC) inactive state; and
in the RRC inactive state, determining a frequency priority in cell reselection based on the designation information without applying processing of considering a frequency determined by the user equipment to be a highest priority in the cell reselection.

### (8) Supplementary Note 2

Supplementary matters relating to the embodiments described above will be described as supplementary notes.

### 1. Introduction

Work items relating to extension of the MBS (eMBS) are intended to support multicast reception by a UE in the inactive state as follows.
To define support for multicast reception by the UE in the RRC inactive state.
A PTM configuration of the UE that receives multicast in the RRC inactive state
To investigate influences of mobility and state transition of the UE that receives multicast in the RRC inactive state (seamless/lossless mobility is unnecessary).

RAN2 has started a discussion for this purpose and reached a series of agreements. Moreover, details of multicast reception in the inactive state are discussed in this supplementary note.

### 2. Discussion

### 2.1. Distribution Mode Baseline

According to Rel-17, two distribution modes have been defined. That is, a distribution mode will be referred to as “distribution mode 1” in a case of multicast sessions and “distribution mode 2” in a case of broadcast sessions. Thus, although a configuration for receiving the MTCH is provided to only the UE connected in the distribution mode 1 through the RRC reconfiguration, the configuration is provided to all UEs in the RRC state in the distribution mode 2 through the MCCH.

RAN2 #119e has identified that these distribution modes are candidates for multicast reception in the inactive state, i.e., option 1 and option 2. Thus, a “combination (Mix)” of these options is also described in a table.

As for distribution of the PTM configuration, RAN2 further investigates the following solutions.
Option 1; Dedicated signaling
Option 2: Solution based on SIB+MCCH
   The “combination (Mix)” of the options is not excluded.

RAN2 #119bis-e has further agreed to the general description of option 1 and option 2.

The following general description is adopted as a baseline for PTM Configuration Distribution Option 1.
(1-a) The PTM configuration of one or more multicast sessions for at least one cell (i.e., a configuration used for multicast reception in the RRC inactive state) is provided to the UE via dedicated RRC signaling.
(1-b) The RRC message for this PTM configuration includes RRCReconfiguration and/or RRCRelease and/or RRCResume (details need to be further studied).
(1-c) When the UE, during the RRC inactive state, needs to save the received configuration and update part or entirety of the configuration, the UE is notified of such a change and may trigger RRC Connection Resume to acquire the updated configuration. In a case of mobility in the RRC inactive state, if a session configuration cannot be used in a new cell, the UE triggers Resume of RRC connection.

The following general description provides a baseline for PTM Configuration distribution Option 2.
(2-a) The PTM configuration (i.e., the configuration used for multicast reception in the RRC inactive state) is provided via a channel such as an MCCH (that is the same as or different from that used for MBS broadcast), and the information relating to MCCH scheduling is provided via an SIB or dedicated signaling (which needs to be further studied).
(2-b) The UE can receive such a configuration when the UE is in the RRC inactive state. Whether the UE is also permitted or needs to receive the configuration in the RRC connected state needs to be further studied.
(2-c) If part or entirety of the received configuration needs to be updated, the UE does not need to resume RRC connection, yet is notified of such a change (e.g. via MCCH DCI) and acquires the updated configuration via the MCCH.

According to contributions submitted so far from companies, support for multicast reception in an inactive state is motivated for two reasons of network congestion and UE power saving.

Observation 1: The motivations for multicast reception in the inactive state are the network congestion and the UE power saving.

According to this supplementary note, option 1 is superior to option 2 in terms of a signaling overhead that directly influences network congestion. In other words, from a viewpoint of motivations, permitting an additional signaling overhead caused by the SIB 20 and MCCH transmission does not make any sense when the network is congested.

Observation 2: The signaling overhead caused by MCCH transmission is very important in a state where the network is congested.

From the viewpoint of the UE in the inactive state, the UE executes DRX for paging monitoring to reduce power consumption. When option 2 is selected for multicast reception in the inactive state, the UE needs to execute an additional DRX activity, that is, MCCH monitoring, which causes additional power consumption. Accordingly, this is not consistent with the motivation of power saving of the UE.

Observation 3: An MCCH monitoring activity causes additional UE power consumption in the RRC inactive state.

Of course, according to option 1, the UE is obliged to start an RRC Resume procedure when the MBS configuration is provided or updated. In this regard, it is clarified that “it is not assumed that, when an MRB is configured and a session is activated, the configuration is not frequently changed during the session”. It has also been agreed in RAN2 #119e that “continuity of the multicast service after cell reselection in the RRC inactive state (i.e., without resuming RRC connection) is supported (when a configuration of a new cell can be used by the UE)”. Accordingly, a major problem does not occur regarding network congestion and UE power consumption.

It is a common understanding of RAN2 that Rel-17 defines that multicast services are provided by the so-called distribution mode 1 (i.e., option 1), which is a basic concept of multicast design. There exists no reason to add such substantial changes between releases.

In view of the above observations, option 1 is simple for distribution of the PTM configuration.

Proposal 1: RAN2 needs to agree that the PTM configuration is provided by dedicated signaling, that is, option 1.

### 2.2. RRC State Transition

According to RAN2 #119e, an aspect relating to RRC state change has been study required matters.

According to Rel-18, multicast reception for the UE in an inactive state supports at least the following scenarios on the assumption that the UE already has a valid PTM configuration.
Scenario 1: The UE receives multicast in a connected state, enters the inactive state, and continues multicast reception.
Scenario 2: When the UE joins a multicast session and the inactive state is indicated, the UE starts receiving a multicast session.

Details of a reason or the like that a service is not provided in an inactive state need to be further studied.

Many aspects relating to change in RRC states are considered to exist from viewpoints of the network and the UE. Accordingly, the aspects will be described on a case-by-case basis.

### 2.2.1. Subcase 1: Deactivation/Release of Multicast Session

RAN2 #119bis-e has agreed that the UE is notified when a multicast session is deactivated, and the Rel-17 mechanism is applied when the multicast session is released.

If the UE is in the RRC inactive state and is configured to receive the multicast session in the RRC inactive state, the UE can receive a notification when the multicast session is deactivated. Methods need to be further studied (the multicast session is notified via group paging, an MCCH, or other methods).

The Rel-17 mechanism (NAS-based indication) is applied to release the multicast session. A case where extension is needed needs to be further studied.

When the UE in the inactive state is receiving an MBS service, the multicast session is considered to be deactivated or released, and a gNB is likely to stop transmission of the PTM/MTCH in response to this release. In this case, although the UE has no reason for continuing monitoring the MTCH, as long as the PTM configuration is not deleted, the UE needs to continue monitoring the MTCH. From the viewpoint of power saving of the UE, it is desirable to stop monitoring the MTCH as soon as possible.

Observation 4: It is inefficient from the viewpoint of power consumption of the UE that the UE continues monitoring the PTM/MTCH even after the multicast session is deactivated or released.

Accordingly, it is valuable to clarify an operation of the UE at a time of deactivation of the multicast session. That is, when receiving a notification of deactivation of the multicast session whatever notification method is used, the UE needs to be able to stop monitoring the MTCH. When such a notification is received, the UE needs to remain in the RRC inactive state.

Proposal 2: RAN2 needs to agree that, when receiving deactivation of the multicast session, the UE can stop monitoring the MTCH.

In a case of deactivation of the multicast session, RAN2 needs to further study a method for notifying the UE of the inactivation by group paging, the MCCH, or other methods.

According to LTE SC-PTM, to give a notification that the UE stops monitoring a PDCCH of a G-RNTI, an SC-PTM Stop Indication MAC CE is introduced, and the MAC CE is multiplexed on an SC-MTCH associated with the G-RNTI. This lightweight signaling may function under restriction of a one-to-one mapping between the TMGI and the G-RNTI. On the other hand, since many-to-one mapping between the TMGI and the G-RNTI is permitted for an NRM BS, the deactivated TMGI needs to be indicated when the MAC CE is introduced. Since the MAC CE is transmitted together with the MTCH, it is expected that delay from reception of last multicast data to stop of MTCH monitoring is minimized.

Another option is to reuse group paging. Group paging is used to simultaneously page a plurality of UEs in a group using the TMGI instead of a UE-ID. Since the existing paging group list (i.e., a list of TMGIs) can be applied to legacy UEs, group paging needs to add a new TMGI list for deactivation notification to avoid an influence on the legacy UEs. The group paging is transmitted in a paging occasion. That is, some delay occurs between reception of the last multicast data and stop of MTCH monitoring based on an I-DRX cycle.

The third option is to reuse the MCCH. There exist two possibilities for a method for giving a notification of deactivation of the multicast session. That is, the methods include deleting the PTM configuration of the deactivated TMGI, and adding a new notification for giving the notification of the deactivated TMGI. In any case, since the MCCH needs to be updated, an MCCH change notification needs to be transmitted to the UE in advance. Hence, a delay from reception of the last multicast data to stop of MTCH monitoring becomes long. Since the UE needs to wake up to acquire the MCCH, and an MCCH change boundary is produced once in addition to an MTCH occasion and I-DRX, power consumption increases compared to the above other options.

In consideration of the above, it is desirable to select a new MACCE and/or extended group paging to provide a notification of stop of the multicast session from a viewpoint of resource efficiency and power consumption of the UE.

Proposal 3: RAN2 needs to agree to select a new MACCE and/or extended group paging for notification of deactivation of the multicast session.

As for release of the multicast session, an NAS-based notification of Rel-17 agreed by RAN2 applies, which may be “release of a multicast session requested by the network or release of the MBS session”. This procedure assumes that the UE is paged by the gNB and transitions to the RRC connected state to communicate with the AMF. In this procedure, it is assumed that existing group paging (or known dedicated paging) can be reused.

That is, the gNB can transmit the MAC CE to enable the UE to stop monitoring the MTCH and then allow the UE to be paged at a different timing by using legacy dedicated paging to avoid a signaling storm due to simultaneous RRC state transition.

Proposal 4: RAN2 needs to agree that function extension specialized in multicast session release is not necessary, i.e., the UE transitions to the RRC connected state by existing (group) paging.

### 2.2.2. Subcase 2: Selective Transition

RAN2 #119e has reached the following agreement relating to subcase 2. The gNB determines whether the UE can receive a multicast session in the inactive state. What information is to be provided (in relation to the discussion of SA2) to the gNB to make such determination needs to be further studied.

It is supported that the gNB transmits one multicast session to UEs both in the connected state and the inactive state in the same cell. How the gNB configures this support needs to be further studied.

It is assumed that the network can select which UE receives the multicast session in the RRC inactive state and which UE receives the multicast session in the RRC connected state, and can move the UE between states for reception of the multicast service.

When the gNB releases the UE to the inactive state, the gNB can select which UE to release in the same manner as the current manner, that is, by RRCRelease with Suspend Config., based on UE capability, UE assistance information, and/or CN assistance information (when defined). Hence, as for RRCRelease messages, no functional enhancement relating to selective transitions of the UE is not predicted.

Observation 5: Existing RRCRelease is used for the gNB to select which UE to release.

For activation of a multicast session, RAN2 #119bis-e has agreed on the following sentence.

When a Rel-18 session is activated, the UE in the inactive state can be notified (details need to be further studies).

As a baseline, group paging can be used to notify the Rel-18UE of activation of a session (e.g., further study is necessary for details of an operation of the UE or the like at a time when the UE receives such a group notification).

A method for determining whether a UE can receive a multicast session in the RRC inactive state when the session is activated will be described in study required matters in consideration of the following solutions (the description can be further updated as needed and a plurality of solutions may be necessary).

1. When a multicast session is activated, if the PTM configuration used in the RRC inactive state for the session can be used by the UE and the UE already joins the session (such as a configuration provided to the UE via dedicated RRC signaling or an MCCH), the UE can receive the multicast session in the RRC inactive state, otherwise returns to the RRC connected state and receives the multicast session.

2. When a multicast session is activated, whether the UE can receive the multicast session in the RRC inactive state is indicated by group paging (detailed signaling needs to be further studied).

3. “Whether the UE can receive a multicast session in the RRC inactive state” is configured by dedicated signaling for the UE before the UE is released. Once the multicast session is activated, the UE remains in the RRC inactive state or resumes RRC connection in response to the activation (detailed signaling needs to be further studied).

According to Rel-17, activation of a multicast session is provided as notification through group paging. Since it is not necessary to distinguish between Rel-18 and legacy mechanisms, RAN2 needs to check that group paging is used to notify UEs of activation of a multicast session.

Proposal 5: RAN2 needs to check that group paging can be used to notify Rel-18 UEs of activation of the session.

Upon checking, RAN2 has specified three options for an operation of the UE at a time of reception of a multicast activation notification as mentioned above.

In the case of option 1, the UE can receive the multicast session in the inactive state if there exists a valid PTM configuration. The UE in the inactive state cannot receive a multicast session without the PTM configuration, which can be considered to be a baseline for all other UE operations. Hence, option 1 needs to be agreed upon.

Proposal 6: According to RAN2, when operation option 1 of the UE: a multicast session is activated, if the PTM configuration used in the RRC inactive state for the session can be used by the UE, and the UE has already joined the session (a configuration provided to the UE via dedicated RRC signaling or an MCCH), the UE can receive the multicast session in the RRC inactive state.

In a case of option 2, whether the UE needs to receive the multicast session in the inactive state is indicated at a time when the UE receives group paging.

In a case of option 3, the UE indicates in advance by RRC reconfiguration or RRC Release whether the UE needs to receive the multicast session in the inactive state.

These options may be very similar mechanisms except for a message for making such an indication to the UE. That is, these options can be analyzed from a viewpoint of the motivation described in above observation 1.

In the case of network congestion, it is assumed that a cell load changes from time to time. According to option 2, since the notification is transmitted in group paging, the gNB can consider the latest load situation when determining whether to keep the UE in the inactive state. On the other hand, according to option 3, since the gNB predicts a future load when providing a notification to the UE, there exists a possibility where the cell load is changed when the gNB actually transmits the group paging. Therefore, there exists a risk that the number of UEs that transition to the connected state increases even when congestion worsens, or the number of UEs that remain in the inactive state increases even when the congestion is resolved. Therefore, option 2 is desirable to efficiently control the RRC state of the UE.

It is assumed that some “power saving preference” is introduced into the UE Assistance Information from a power saving case of the UE. Such a preference notification can be transmitted only from a connected UE. Hence, the gNB can indicate to the UE whether the UE is permitted to receive a multicast session in the inactive state when the UE is previously in the connected state. If such a preference notification is not introduced, since the gNB does not know whether the UE prefers power saving, the gNB can transmit this notification at any time. That is, there exists no difference between option 2 and option 3.

In light of the above analysis, option 2 is considered to be more efficient and cover the usage of option 3. Therefore, RAN2 needs to agree on at least option 2.

Proposal 7: RAN2 needs to agree on a UE operation option 2 stating that “when a multicast session is activated, whether the UE can receive the multicast session in the RRC inactive state is indicated to the UE through group paging (detailed signaling needs to be further studied)”.

As for the group paging of option 2, the current specification defines the operation of the UE at a time when the group paging is received, that is, defines that, when the paging message includes a TMGI of interest, all UEs start the RRC Resume procedure, and therefore when selective paging is necessary for option 2, the gNB cannot include the TMGI in a paging message. When the gNB includes only the UE-ID for selective paging (i.e., legacy dedicated paging that is for paging the selected Rel-18UE and that does not use the TMGI), the Rel-17 UE that waits for activation of multicast in the inactive state cannot be paged. This is also inefficient in terms of a signaling overhead.

Observation 6: That is, when the paging message includes the TMGI of interest, all UEs transition to the RRC connected state.

Assuming that a current paging group list is configured in the group paging message and at least the Rel-17 UE is paged, the Rel-18 UE is also paged through the TMGI of interest. Hence, in order to keep the selected UE from transitioning to the connected state, it is considered to define “pagingcancellist” (or “inactiveallowedlist”) that is a new list of UE-IDs and keep the UE listed in this list in the inactive state to allow the UE to receive the multicast session.

Hence, RAN2 needs to discuss a method for enhancing group paging to page a subset of UEs.

Proposal 8: RAN2 needs to discuss a method for enhancing group paging for paging a subset of UEs using, for example, a new UE-ID list for remaining in the inactive state for reception of a multicast session.

### 2.2.3. Subcase 3: QoS Enforcement

RAN2 #119e has reached the following agreement relating to subcase 3.

HARQ feedback and PTP are not supported for multicast reception in the RRC inactive state.

According to the agreement, multicast reception in the inactive state is the same as or similar to MBS broadcasting reception defined in Rel-17 (so-called distribution mode 2). MBS broadcast is performed on a best effort basis.

On the other hand, ensuring QoS/reliability is an important task for multicast sessions. SA2 has also questioned whether there exists a difference in the qualities/reliabilities of multicast reception between the connected state and the inactive state, and RAN2 #119bis-e has agreed on the following answers.

RAN2Q1-a) A case where there exists a significant difference in qualities and reliabilities of MBS data reception between a UE in the RRC connected state and a UE in the RRC inactive state:

The qualities and the reliabilities of the MBS data reception between the UE in the RRC connected state and the UE in the RRC inactive state may be different because HARQ feedback and PTP transmission are not supported, and seamless/lossless mobility is not required for multicast reception in the RRC inactive state.

The qualities and the reliabilities of the MBS data reception between the ULE in the RRC connected state and the UE in the RRC inactive state may be different because HARQ feedback and PTP transmission are not supported, and seamless/lossless mobility is not required for multicast reception in the RRC inactive state.

RAN2 #119e has proposed to introduce threshold values for reception qualities such as RSRP and BLER, and the threshold values are considered to be used to ensure a certain level of QoS required for multicast reception. The threshold values are also helpful for the network to manage QoS requirements. When multicast reception in the inactive state does not meet the corresponding QoS requirements, the UE needs to transition to the connected state and ensure reception quality by using HARQ feedback/retransmission or PTP (or SplitMRB).

Observation 7: Even when the LE is in the inactive state, the multicast session needs to ensure certain QoS requirements.

As for the threshold value for RSRP, since an NRMBS assumes a single-cell transmission method, the UE is considered to be required to always transition to the connected state every time the UE moves to a cell edge or performs cell reselection. This operation is not likely to be an optimal operation depending on deployments from the viewpoint of network congestion and power saving of the UE.

The threshold value for a BLER is considered to be simpler to ensure the QoS requirements. Accordingly, to introduce transitions of RRC states based on reception qualities, these options need to be discussed.

Proposal 9: RAN2 needs to agree that, when the reception quality becomes worse than the threshold value (such as the RSRP or the BLER), the UE in the inactive state transitions to the connected state.

### 2.2.4. Subcase 4: Mobility and Service Continuity

RAN2 #119e has agreed on the following description relating to subcase 4. Continuation of the multicast service after cell reselection in the RRC inactive state (i.e., without resuming RRC connection) is supported (when a configuration of a new cell can be used by the UE). Whether there exists a case where the UE needs to resume connection needs to be further studied. An influence of inter-GNB mobility on RAN3 also needs to be further studied.

When cell reselection for a neighboring cell is performed during an active multicast session, and the UE in the inactive state cannot use the session configuration in a new cell, the UE needs to resume RRC connection and acquire a multicast MRB configuration.

RAN2 #119bis-e has identified a problem of distribution mode option 1.

The following general description is a baseline of PTM Configuration distribution Option 1:
(1-a) The PTM configuration of one or more multicast sessions of at least one cell (i.e., the configuration used for multicast reception in the RRC inactive state) is provided to the UE via dedicated RRC signaling.
(1-b) The RRC message for this PTM configuration includes RRC Reconfiguration and/or RRC Release and/or RRC Resume (the details need to be further studied).
(1-c) When the UE, during the RRC inactive state, needs to save the received configuration and update some or all of the configuration, the UE is notified of such a change and can trigger Resume of RRC connection to acquire the updated configuration. When mobility occurs in the RRC inactive state, if a session configuration cannot be used in the new cell, the UE triggers Resume of the RRC connection.

In the distribution mode 1 of Rel-17, since the PTM configuration is provided by an RRC Reconfiguration message, the UE needs to be in the connected state always to receive the PTM configuration. To avoid transition to the connected state, it is considered to provide the PTM configuration updated using the RRC release message. In this case, the UE transmits the RRC Resume Request message, and the gNB responds to RRC Release including the PTM configuration. Thus, the UE does not need to transition to the connected state to be provided with the updated PTM configuration. This procedure can be used at a time of cell reselection (i.e., a procedure started by the UE when the PTM configuration cannot be used by a new cell) or at a time of RAN paging (i.e., a procedure started by the network when the PTM configuration needs to be updated).

Proposal 10: RAN2 needs to agree that RRC Release is enhanced to provide a PTM configuration.

Another problem that needs to be considered is an influence of UE mobility under the assumption that “seamless/lossless mobility is not necessary” as described in the WID. RAN2 #119bis-e has agreed on matters that need to be further studied.

Whether to introduce a PTM configuration application area, that is, a mechanism in which the PTM configuration once acquired by the UE is applied to a specific area (i.e., a set of cells rather than a single cell) is a matter that needs to be further studied.

According to Rel-17, it is clear that the PTM configuration in the distribution mode 1 is valid only in the cell to which the UE is configured. When handover is executed, the target cell reconfigures the UE in accordance with a new PTM configuration. On the other hand, when the UE in the inactive state executes mobility in the idle mode, it can be considered as the starting point when the existing PTM configuration is no longer valid in a reselected cell (i.e., new cell).

In order for the UE to be handed over from a serving cell to a target cell or reconfigured by a reselected cell, requesting transition of the UE in the inactive state to a connected state (e.g., before or after executing cell reselection) may be the simplest solution with a minimal influence on the specification.

As a more efficient method, since the PTM configuration is valid in the RNA, the gNB needs to be able to apply the same configuration in the RNA of each UE. An advantage of this method is that the UE in the inactive state does not need to be reconfigured and can continue receiving the MTCH in the RNA. On the other hand, the RNA is unique to the UE, and therefore the network becomes complex.

A more flexible and less complex method may be that the gNB provides a cell list in the configuration and thereby the configuration can be considered to be valid in the cells included in the list. The cell list can be configured to at least one selected from the group consisting of cell-specific, DU/CU-related, UE cell list-related, MRB area-specific, or MBS service area-specific, yet depends on implementation of the NW.

Therefore, RAN2 needs to discuss whether to introduce an area scope of such configurations.

Proposal 11: RAN2 needs to discuss whether the configuration for receiving the MTCH is valid in a serving cell or valid in an area (such as the RNA or cell list).

### (9) Supplementary Note 3

### 1. Introduction

Work items relating to MBS enhancement (eMBS) include the purpose of supporting UE shared processing for MBS broadcast and unicast as follows:
Extension of Uu signaling for enabling the UE to use shared processing for MBS broadcast and unicast reception is defined. That is, the work items include a report of UE capability and related assistance information relating to simultaneous reception of unicast reception in the RRC connected state and MBS broadcasting reception from the same or different business operator is included.

### 2. Discussion

### 2.1. Agreed Mechanism Based on LTE Solution

RAN2 #119bis-e has achieved some matters that need to be further studied and the following agreement based on the LTE ROM solution.

For the shared processing, the following is adopted as a baseline:
1) A new IE has been added to system information to control whether MBSInterestIndication for the shared processing can be transmitted;
2) Contents of an MBSInterestIndication message and related procedures are updated for the shared processing.

A new IE that controls whether MBSInterestIndication of the shared processing can be transmitted has been added to the SIB1.

In MBSInterestIndication, at least the following information can be signaled for broadcasting services that the UE is receiving or is interested in receiving: a broadcast frequency, a subcarrier spacing, and a bandwidth. Detailed/accurate parameters and other information need to be further studied. In which scenario the UE reports this information (e.g., in a case of an intra-PLMN or in a case of an inter-PLMN) needs to be further studied.

Whether capability of the UE is necessary to enable the shared processing is checked as a matter that needs to be further studied.

According to this solution, the gNB can allocate unicast resources to the UE under a condition that processing capability of the UE does not exceed its capability. Since the processing capability is assumed to be common between the intra-PLMN and the inter-PLMN, whether to report an extended MBS Interest Indication (MII) depends on whether the serving cell has knowledge relating to the MBS broadcast configuration provided at different frequencies and/or in the different PLMNs. In this sense, the new IE of the SIB1 needs to indicate whether the UE needs to report the extended MII only in a case of the inter-PLMN or also in a case of the intra-PLMN. The UE checks whether there exists a difference between a serving PLMN and an MBS PLMN (from the TMGI) and follows the indication of the SIB1L Therefore, RAN2 needs to discuss whether a 1-bit notification is sufficient (i.e., in the case of ON/OFF of the extended MII) or whether a multiple-bit notification is necessary (i.e., in the case of the inter-PLMN and/or the intra-PLMN).

Proposal 1: RAN2 needs to discuss whether the new IE of the SIB1 needs to control whether the UE reports the extended MBS Interest Indication for shared processing only in the case of the inter-PLMN or also in the case of the intra-PLMN.

Another matter that needs to be further studied relates to UE capability. Since only UEs capable of shared processing can transmit the extended MII, it is clear that UE capability signaling is unnecessary and the extended MII is considered to be implicit capability signaling. Hence, RAN2 needs to agree on the principle of the UE capability signaling.

Proposal 2: RAN2 needs to agree that the UE capability signaling is not necessary for the shared processing.

### 2.2. Sharing RF Chain

The mechanism agreed in Section 2.1 is mainly to share the processing capability of the UE. On the other hand, how to share an RF chain of a UE is worth studying.

### 2.2.1. MBS Gap for RF Sharing in Time Domain

### 2.2.1.1. Gap Configuration

A justification part of the WID clearly indicates that the UE receives an MBS service of interest from a different business operator, that is, inter-PLMN MBS reception, and thus some keywords are highlighted.

According to a Rel-17 NR MBS broadcast solution, the UE can receive a broadcast service only on the downlink. However, in a typical use case of broadcast, the UE may need to simultaneously receive a broadcast service and a unicast service from a network of the same business operator or a different business operator, and some UEs may share hardware resources between broadcast and unicast. For this type of UE, a unicast connection is likely to be influenced by a broadcast reception. Optimization in such cases is not particularly addressed in Rel-17 and cases of unicast reception in the RRC connected state and broadcasting reception from the same or different business operators need to be focused, the broadcasting reception including emergency broadcasting and public safety broadcasting.

In the case of the shared processing, the UE can use the same reception device for MBS broadcast and unicast. As described above, the MBS service may be provided by the different business operator, and therefore may be provided at a different frequency. When one reception device is used for the different frequency, the UE needs to tune the RF chain to these frequencies in a TDD manner. Therefore, an additional gap for MBS broadcasting reception is necessary for the shared processing. Since the gNB avoids scheduling of DL transmission for unicast during this gap, the UE can receive MBS broadcasting of interest at the different frequency/business operator. This is similar to a measurement gap for inter-frequency measurement or a MUSIM gap for an inter-PLMN operation.

Observation 1: The UE can tune the RF chain to a frequency different from the MBS frequency while the gNB does not schedule unicast transmission and reception.

Whether an existing MUSIM gap can be reused for MBS reception matters for the gap. Technically speaking, the MUSIM gap can be extended for MBS reception. However, according to the current specification, the MUSIM gap is limited to a purpose of the MUSIM as follows. It is clear that a current MUSIM gap is not intended to be used for MBS reception.

When the UE needs a gap pattern for the purpose of the MUSIM such as cell identification and measurement, paging monitoring, SIB acquisition, and/or an on-demand SI request of a target cell of a target network, the network can provide a MUSIM gap pattern for each of one or more UEs for simultaneous monitoring of all frequency layers for the MUSIM via MUSIM-GapConfig.

When the same gap is used for different purposes, unnecessary complexity is predicted to be produced. Actually, the MUSIM gap is introduced separately from an existing measurement gap in Rel-17. Accordingly, it is desirable to introduce an additional gap that is different from the MUSIM gap and is specialized in inter-frequency/inter-PLMN MBS reception.

Proposal 3: RAN2 needs to agree to introduce additional gaps for inter-PLMN reception of MBS broadcast in the RRC connected state in particular, that is, an “MBS gap”.

### 2.2.1.2. Gap Assistance Information

When proposal 3 is agreed, the gNB needs to configure the MBS gap for the UE, but the gNB does not know what gap pattern the UE needs. Therefore, the UE needs to transmit assistance information to notify the gNB of details of the necessary gap, which intends for the purpose of this WI. Since the current network (i.e., selected PLMN) does not know the details of MBS broadcasting configurations of different business operators such as the MTCH scheduling information, this assistance information may be useful particularly when MBS broadcasting of interest is provided by a different business operator. This is similar to MUSIM assistance introduced in UAI.

Proposal 4: RAN2 needs to agree to introduce additional assistance information from the UE to an MBS gap configuration particularly when the MBS broadcasting of interest is provided from another PLMN.

When proposal 4 can be agreed, it is worth studying what assistance information is necessary. According to Rel-17, the UE can notify the gNB of the MII including the TMGI, the frequency, and priority of MBS broadcast and unicast. According to Rel-18, RAN2 has agreed to an extended MII including additional information such as a subcarrier spacing and a bandwidth. When the same business operator provides MBS broadcasting of interest, if the gNB knows MTCH scheduling information of a specific TMGI provided at a different frequency, the MII is likely to function well.

Since the gNB of the selected network does not know an MBS broadcast configuration of a different network, if the different business operator provides MBS broadcast of interest, the UE needs to provide a gap pattern to the gNB. The gap pattern needs to be based on the MTCH scheduling information of the different business operator, yet the reference needs to be based on the selected network. An RF tuning time may be also included, and how to configure the gap pattern is left to the UE implementation.

Proposal 5: In a case of inter-PLMN MBS reception in particular, RAN2 needs to agree that the UE requests a gap pattern to the gNB, and thereby the gap pattern can cover an RF adjustment time and an MTCH scheduling period of different PLMNs.

### 2.2.2. Deconfiguration/Deactivation of SCells for RF Sharing

According to RAN2 #119e, there has been an opinion that a gap mechanism is complex in terms of the network. In this case, whether to permit the MBS gap and assistance information associated with the MBS gap depends on implementation of the network. In this regard, when all the reception devices of the UE are used for unicast transfer of a serving network, a fundamental problem remains as to a method of the UE for receiving the MBS service from the different network (for example, when the UE cannot receive the MBS service of interest due to a carrier aggregation configuration).

One of simple methods for enabling the UE to use one of the reception devices thereof for MBS reception include that the gNB de-configures or deactivates one of currently active SCells for the UE. However, since it is likely that the gNB does not know whether the UE prefers SCell de-configuration/deactivation or when the UE prefers SCell de-configuration/deactivation, it is worth discussing whether the additional assistance information of SCell de-configuration/deactivation for MBS reception is useful in addition to the above MBS gap. When the additional assistance information is recognized as useful, whether contents of a current MII, that is, a frequency and a priority work for a purpose thereof needs to be discussed.

Proposal 6: RAN2 needs to further discuss whether the UE is permitted to notify the gNB of a priority relating to reconfiguration or deactivation of the SCell for MBS reception from a different PLMN.

### REFERENCE SIGNS

1: Mobile communication system
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method executed by a user equipment in a mobile communication system for providing a Multicast/Broadcast Service (MBS), the communication method comprising the steps of:
performing multicast reception in a Radio Resource Control (RRC) inactive state based on a multicast configuration received from a network through dedicated signaling;
determining to access the network for update of the multicast configuration in response to determination that the update is necessary; and
determining whether to apply or skip access control for restricting the access, based on configuration information from the network.

2. The communication method according to claim 1, further comprising receiving the configuration information from the network,
wherein the configuration information is information for configuring whether to permit the user equipment to skip the access control when the access is performed only for a purpose of the update.

3. A communication method executed by a user equipment in a mobile communication system for providing a Multicast/Broadcast Service (MBS), the communication method comprising the steps of:
performing multicast reception in a Radio Resource Control (RRC) inactive state based on a multicast configuration received from a network; and
in the RRC inactive state, considering a frequency to which a cell having transmitted the multicast configuration belongs to be a highest priority in cell reselection.

4. A communication method executed by a user equipment in a mobile communication system for providing a Multicast/Broadcast Service (MBS), the communication method comprising the steps of:
receiving, from a network, dedicated signaling including designation information for designating a frequency;
performing multicast reception in a Radio Resource Control (RRC) inactive state; and
in the RRC inactive state, determining a frequency priority in cell reselection based on the designation information without applying processing of considering a frequency determined by the user equipment to be a highest priority in the cell reselection.
